(19) United States
(12) Patent Application Publication
(10) Pub. No.: US 2025/0329910 A1
(43) Pub. Date: Oct. 23, 2025

(54) DIRECTIONAL COUPLER

(71) Applicant: Telefonaktiebolaget LM Ericsson (publ), Stockholm (SE)

(72) Inventors: Christos KOLITSIDAS, Hasselby (SE); Jason PERRIN, Bouguenais, Loire-Atlantique (FR); Martin PETEK, Torino (IT); Darwin BLANCO, Hasselby (SE); Nelson FONSECA, Noordwijk (NL); Oscar QUEVEDO-TERUEL, Stockholm (SE)

(21) Appl. No.: 19/126,193

(22) PCT Filed: Sep. 11, 2023
(86) PCT No.: PCT/EP2023/074900

§ 371 Date: Apr. 30, 2025

(30) Foreign Application Priority Data
Nov. 4, 2022 (GR) 20220100905

(51) Int. Cl. H01P 5/18; H01Q 1/24; H01Q 3/36

(52) U.S. Cl. CPC H01P 5/184; H01Q 3/36; H01Q 1/246

(57) ABSTRACT

Example directional couplers and devices including one or more directional couplers are disclosed. In an example, a directional coupler comprises a first electrically conductive portion and a second electrically conductive portion, a first ground plane electrical conductor disposed in a plane between the first electrically conductive portion and the second electrically conductive portion, and a second ground plane electrical conductor and a third ground plane electrical conductor disposed such that the first and second electrically conductive portions and the first ground plane electrical conductor are between the second and third ground plane electrical conductors. The first ground plane electrical conductor includes at least one hole directly between the first electrically conductive portion and the second electrically conductive portion.

### TECHNICAL FIELD

Example embodiments of this disclosure relate to a directional coupler, a phase shifter such as for example a directional coupler configured as a phase shifter, and one or more devices that include one or more directional couplers.

### BACKGROUND

A directional coupler is a four-port device which, when excited in one port, splits the signal towards two ports with a phase shift while isolating the fourth port. The signal is directed towards the coupling element via four transmission lines. The coupling element is responsible for splitting the power and ensuring the phase shift. If the power is spread equally, it is called a 3 dB hybrid, or hybrid coupler. Hybrid couplers find significant usage in devices and scenarios such as a transmit observation receiver (TOR), calibration networks, beamforming networks (Butler, Blass, Nolen), etc. They are an important component that can be found close to an antenna/antenna array used by some devices, which makes it crucial to be as low loss and as compact as possible.

Highly directional base station antennas are used in order to steer beams toward users, to cope with the ever-increasing amount of data. Current base station antenna arrays have large numbers of radiating antenna elements that are needed for high spatial resolution. Each single element should ideally be individually controlled, both in phase and magnitude, to have optimal beam steering capabilities, which is the case with digital beamforming. However, when using arrays composed of dozens of elements, the individual control of each of them can result in high complexity and cost. A less complex solution consists in using analogue beamforming techniques in the form of Beam Forming Networks (BFNs), such as Butler matrices, to form the beams. An example of the block diagram of a 4×4 Butler matrix 100 is shown in FIG. 1.

The first description of a Butler matrix dates to 1961 [1] and it has been widely used since. A Butler matrix is a theoretically lossless BFN introducing multiple progressive phase differences. A Butler matrix has the same number of input and output ports, which is a power of two in its standard form. Butler matrices have been implemented in a variety of technologies, such as microstrip [2], stripline [3], [4], [5], Substrate Integrated Waveguide (SIW) for millimeter waves [6], [7] or even lumped elements [8]. They have often been used for analogue 1D beam forming, but they can also be adapted to feed 2D antenna arrays [9].

A Butler matrix is built with directional couplers and phase shifters. Many directional couplers built with PCB technology can be found in the literature. Microstrip quadrature slot couplers, along with the Lange coupler and multisection couplers are some of the few wideband transmission line couplers—2:1 bandwidth ratio or more—and capable of achieving tight coupling, or 3 dB coupling, described in the literature [10-19]. Wideband, compact phase shifters have also been proposed from modified microstrip quadrature slot couplers for instance [19-21].

In the example Butler matrix 100 shown in FIG. 1, input ports 1 and 2 are provided to a first directional coupler 102, and input ports 3 and 4 are provided to a second directional coupler 104. An output of the first directional coupler 102 is provided to a third directional coupler 106 via a first 45° phase shifter 108, and another output of the first directional coupler 102 is provided to a fourth directional coupler 110. An output of the second directional coupler 104 is provided to the third directional coupler 106, and another output of the second directional coupler 104 is provided to a fourth directional coupler 110 via a second 45° phase shifter 112.

Outputs 5 and 6 of the Butler matrix 100 are provided by the third 106 and fourth 110 directional couplers, respectively, and outputs 7 and 8 of the Butler matrix 100 are provided by the third 106 and fourth 110 directional couplers, respectively.

This specific arrangement produces a so-called symmetric Butler matrix with progressive phase differences of +45° and +135° between adjacent output ports.

### SUMMARY

Examples of this disclosure may have certain advantages. For example, proposed directional couplers and devices containing such directional couplers may enable the formation of wideband, shielded, low loss and low cost, small footprint BFNs.

One aspect of the present disclosure provides a directional coupler comprising a first electrically conductive portion and a second electrically conductive portion, a first ground plane electrical conductor disposed in a plane between the first electrically conductive portion and the second electrically conductive portion, and a second ground plane electrical conductor and a third ground plane electrical conductor disposed such that the first and second electrically conductive portions and the first ground plane electrical conductor are between the second and third ground plane electrical conductors. The first ground plane electrical conductor includes at least one hole directly between the first electrically conductive portion and the second electrically conductive portion.

Another aspect of the present disclosure provides a directional coupler comprising a first electrically conductive portion and a second electrically conductive portion, a first planar electrical conductor and a second planar electrical conductor, and a first ground plane electrical conductor disposed in a plane between the first electrically conductive portion and the second electrically conductive portion. The first electrically conductive portion comprises a ridge in the first planar electrical conductor, and the second electrically conductive portion comprises a ridge in the second planar electrical conductor. The first ground plane electrical conductor includes at least one hole directly between the first electrically conductive portion and the second electrically conductive portion.

A further aspect of the present disclosure provides a device including at least one directional coupler according to either of the above aspects.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a block diagram of a 4×4 Butler matrix;

FIG. 2 shows an example of an antenna array;

FIG. 3 is a cross section of an example of directional coupler;

FIG. 4 shows a plan view of the directional coupler of FIG. 3;

FIG. 5 shows a plan view of another example of a directional coupler and its simulated S-parameters;

FIG. 6 shows a plan view of another example of a directional coupler and its simulated S-parameters;

FIG. 7 shows a plan view of another example of a directional coupler and its simulated S-parameters;

FIG. 8 shows a plan view of an example of a Butler matrix;

FIG. 9(a) shows simulated S-parameters and (b) phase difference for an example coupler;

FIG. 10(a) shows simulated S-parameters and (b) phase difference for an example phase shifter;

FIG. 11 shows simulated insertion losses of an example Butler matrix;

FIG. 12 shows simulated reflection and isolation of an example Butler matrix;

FIG. 13 shows phase differences between consecutive output ports of an example Butler matrix;

FIG. 14 shows an exploded view of another example of a directional coupler; according to this arrangement;

FIG. 15 shows a cross section of the directional coupler of FIG. 14;

FIG. 16 shows a cross section of another example of a directional coupler;

FIG. 17 shows a plan view of an example of a microstrip line to RGW transition for a part of the directional coupler of FIG. 16;

FIG. 18 shows simulated S-parameters of the example directional coupler shown in FIG. 16;

FIG. 19 shows simulated phase difference of outgoing signals from the example directional coupler shown in FIG. 16;

FIG. 20 shows simulation results for the structure shown in FIGS. 16 and 17;

FIG. 21 shows simulated S-parameters of the structure shown in FIGS. 16 and 17; and

FIG. 22 shows simulated phase difference between two outgoing signals of the structure shown in FIGS. 16 and 17.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail.

To reduce complexity and cost in an antenna system, especially during manufacturing, it could be very beneficial to have as many functionalities as possible packed in a single board of a Printed Circuit Board (PCB), such as illustrated FIG. 2, which shows an example of an antenna array 200. The antenna array 200 comprises a PCB 202 including an array of antenna elements 204. A 6×6 array is shown in this example. A 2×2 subarray 206 of antenna elements from the centre of the array is shown in exploded view. The subarray 206 includes 2×2 antennas 208 and circuitry 210 in the form of two BFN layers, one for each of two polarizations, in a stacked configuration.

In order to reduce complexity and cost in an antenna system, all the subsystems of the antenna stacked on top of each other must have the same footprint and be electrically shielded in all directions for stacking. The radiating aperture itself has its footprint constrained by the spacing of its radiating elements, that depends on the wavelength in vacuum. When using a BFN such as a Butler matrix, it should therefore be designed such that its footprint is smaller or equal to that of the array it excites. However, Butler matrices used for 2D beamforming have, in general, a footprint that is larger than that of the antennas they excite. If not, they are not wideband [8].

Those issues can be attributed to the constitutive parts of the Butler matrix, that are the couplers and phase shifters. Wideband and compact couplers and phase shifters exist, but are typically found in the form of quadrature slot couplers implemented in microstrip technology, and therefore are not shielded. Therefore, Butler matrices and their constitutive components currently used are not compact enough, not wideband, not shielded, or all of these, and are therefore unsuitable to integrate in the vertical dimension in a device such as an antenna array.

Example embodiments of this disclosure provide a low loss air gapped asymmetric suspended multilayer coupler with arbitrary coupling coefficient. Examples described herein relate to a 3 dB directional coupler, i.e. a hybrid coupler, though the principles disclosed herein may be applied to other directional couplers with a different coupling coefficient.

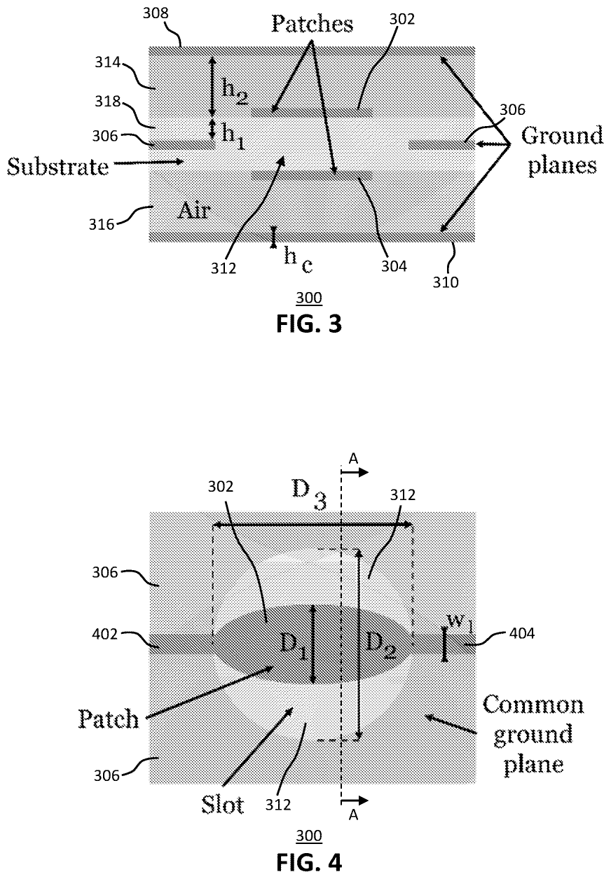

FIG. 3 is a cross section of an example of directional coupler 300. A plan view of the coupler 300 is shown in FIG. 4, where the cross section of FIG. 3 is taken along the line A-A. The directional coupler comprises a first electrically conductive portion 302 and a second electrically conductive portion 304. These may also be referred to in some examples as first and second patches, and form the electrical conductors that are used when the coupler 300 is performing a coupling operation.

The coupler 300 also includes a first ground plane electrical conductor 306 disposed in a plane between the first electrically conductive portion 302 and the second electrically conductive portion 304. The first electrically conductive portion 302, the second electrically conductive portion 304 and the first ground plane electrical conductor 306 are for example not electrically connected together.

The coupler 300 also includes a second ground plane electrical conductor 308 and a third ground plane electrical conductor 310 disposed such that the first 302 and second 304 electrically conductive portions and the first ground plane electrical conductor 306 are between the second 308 and third 310 ground plane electrical conductors. The second 308 and third 310 ground plane electrical conductors are not shown in FIG. 4 for clarity. The first 306, second 308 and third 310 ground plane electrical conductors may for example be substantially parallel, as shown in FIG. 3. As shown in the example coupler 300 of FIG. 3, in the orientation shown, the second ground plane electrical conductor 308 is disposed above the first electrically conductive portion 302, and the third ground plane electrical conductor 310 is disposed below the second electrically conductive portion 304.

The first ground plane electrical conductor 306 includes at least one hole 312 directly between the first electrically conductive portion 302 and the second electrically conductive portion 304. That is, for example, a path in a direct straight line from the first 302 to the second 304 electrically conductive portion may not pass through the first ground plane electrical conductor 306 from at least a portion of the first 302 and/or second 304 electrically conductive portions, and in some examples from all portions of the first 302 and second 304 electrically conductive portions.

In the example shown in FIG. 3, the coupler 300 includes a first air hole 314 (or alternatively a substrate or honeycomb spacer) between the first electrically conductive portion 302 and the second ground plane electrical conductor 308, and a second air hole 316 (or substrate) between the second electrically conductive portion 304 and the third ground plane electrical conductor 310.

In some examples, the first ground plane electrical conductor 306 is embedded within a substrate. For example, as shown in FIG. 3, the first ground plane electrical conductor 306 is embedded within a substrate 318. In some examples, such as shown in FIG. 3, the first electrically conductive portion 302 is disposed on a first surface of the substrate 318, and/or the second electrically conductive portion 304 is disposed on a second surface of the substrate 318 opposite the first surface. In some examples, the substrate 318 may be made formed from multiple layers of substrate, where the first ground plane electrical conductor 306 is for example formed on one of the layers of substrate.

In some examples, the first electrically conductive portion 302 is elongate and the second electrically conductive portion 304 is elongate. That is, for example, the length (e.g. electrical length) of the first 302 and second 304 electrically conductive portions is greater than their width. FIG. 4 shows the length (e.g. electrical length) D3 and width (e.g. electrical width) D1 of the first electrically conductive portion 302. The length D3 is greater than the width D1. In some examples, the length D3 may be at least 2 times D1, at least 4 times D1, or between 2 and 4 times D1. This may also apply to the second electrically conductive portion 304. In some examples, the first 302 and second 304 electrically conductive portions may have the same size and shape, may be disposed in parallel planes, and/or may share the same footprint (e.g. the area underneath the first electrically conductive portion 302 shown in FIG. 4 is the same as the area under the second electrically conductive portion 304, which is hidden in FIG. 4 by the first electrically conductive portion 302). In some examples, the size, shape, arrangement and position of the first electrically conductive portion 302 and the second electrically conductive portion 304 is symmetric with respect to the first ground plane electrical conductor 306.

In some examples, the length D3 of the first electrically conductive portion and/or a length of the second electrically conductive portion D3 is less than a quarter wavelength of an operating frequency of the directional coupler (e.g. less than a quarter wavelength of the highest operating frequency).

In some examples, such as the example shown in FIG. 4, the first electrically conductive portion 302 includes first 402 and second 404 electrical connections at opposite ends of the first electrically conductive portion 302. Similarly, the second electrically conductive portion 304 may in some examples include third and fourth electrical connections at opposite ends of the second electrically conductive portion 304. The third and fourth electrical connections are not shown in FIG. 4 but may be disposed for example underneath the first 402 and second 404 electrical connections respectively. In some examples, the first electrical connection 402 is connected to an input port of the directional coupler 300, the second electrical connection 404 is connected to a transmitted port of the directional coupler 300, the third electrical connection is connected to a coupled port of the directional coupler 300, and the fourth electrical connection is connected to an isolated port of the directional coupler 300.

In some examples, the first electrical connection 402 is connected to the input port of the directional coupler 300, and the second electrical connection 402 is connected the transmitted port of the directional coupler 300. Also, in some examples, the third electrical connection connected to the coupled port is an electrical connection to the second electrically conductive portion 304 that is underneath the first electrical connection 402, and the fourth electrical connection connected to the isolated port is an electrical connection to the second electrically conductive portion 304 that is underneath the second electrical connection 404.

In some examples, the length (e.g. D3 shown in FIG. 4) of the first electrically conductive portion 302 is longer than a length of the at least one hole 312 in a direction of the length of the first electrically conductive portion, and/or the length of the second electrically conductive portion 304 is longer than the length of the at least one hole 312 in a direction of the length of the second electrically conductive portion. Additionally or alternatively, in some examples, the width (e.g. D1 shown in FIG. 4) of the first electrically conductive portion 302 is narrower than the width (e.g. D2 shown in FIG. 4) of the at least one hole 312 in a direction of the width of the first electrically conductive portion, and/or the width of the second electrically conductive portion 304 is narrower than the width (e.g. D2 shown in FIG. 4) of the at least one hole 312 in a direction of the length of the second electrically conductive portion. Therefore, for example, the at least one hole 312 may be directly between some or all of the first 302 and second 304 electrically conductive portions. In some examples, such as in the example shown in FIG. 4, the size of the first hole 312 is larger than a size of the first electrically conductive portion 302 and the size of the second electrically conductive portion 304.

In some examples, the first electrically conductive portion 302 has a substantially elliptical or superelliptical shape, and/or the second electrically conductive portion 304 has a substantially elliptical or superelliptical shape. Additionally or alternatively, the at least one hole includes a first hole that has a substantially elliptical or superelliptical shape. As shown in the example coupler of FIG. 4, the first electrically conductive portion 302 (and the second electrical conductive portion 304, not shown) has an elliptic shape, and the at least one hole 312 comprises a hole that has an elliptic shape that is larger than that of the first electrically conductive portion 302 along at least one axis.

The coupler according to examples described herein, such as for example the coupler 300, may have electrically conductive portions (e.g. patches) and slots/holes of various shapes. More specifically, using superelliptic shapes for the hole(s) and/or patches may for example help to improve performance. The shape optimization as well as the integration with an integrated suspended PCB may offer low loss and the possibility to build up any beamforming network.

A significant advantage of example couplers and phase shifters according to this disclosure is a less than λ_{hf}/4 footprint while keeping low loss, where λ_{hf} is the highest frequency of operation wavelength.

Proposed couplers and devices (e.g. based on PCB integrated suspended stripline couplers) and phase shifters may in some examples enable the formation of wideband, shielded, low loss and cost small footprint devices, antenna arrays and BFNs. In detail, the advantages of example embodiments of this disclosure may include one or more of the following:
1. Fully shielded when compared to a microstrip device.
2. Produced using a low-loss and low-cost PCB integrated suspended stripline technology. In a conventional stripline device, to achieve low loss, high grade and high-cost materials are needed. In proposed embodiments, stack up normal low cost FR4 material may be used for most of the material except a thin core where the coupling occurs. This may help to keep the cost of couplers and devices low.
3. Both wideband and having a small footprint. For example, the fundamental components may have a less than (λ_{hf}/4)² total footprint enabling a 2×2 configuration of less than λ_{hf}×λ_{hf} with an achieved relative bandwidth (BW) of 86%, up to 100%, or beyond one octave, where λ_{hf} is the wavelength at a highest frequency of operation.
4. Planar z-axis integration for two polarizations. For example, the total PCB stack up can support two planar beamforming layers, one for each polarization where they can be stacked on top of each other with standard PCB manufacturing processes.

To further decrease losses and enable such circuitry for higher frequencies using FR4 material, the translation of the coupler in a multilayer gap waveguide technology is illustrated where similar slot aperture coupling is utilized to create the coupler. Similarly, a phase shifter can also be created simply by open circuiting two of the outputs of the coupler, as described more fully below. The footprint here is also kept small and a transition for integration with active circuits has also been developed.

The proposed methodology, couplers, phase shifters and circuits are not limited to the presented circuitry but can in some examples be expanded to any arbitrary coupling coefficient and phase shift value for either the PCB integrated suspended stripline circuit or the gap waveguide equivalent. This may for example provide possibilities for usage of this technology to not only BFNs but also calibration networks, transmit observation receivers (TORs), and other devices.

A directional coupler as disclosed herein may be configured as a phjase shifter, for example by open circuiting the coupled and isolated ports. When referenced with a transmission line, for example, a phase shifting structure can be created.

Some example embodiments of this disclosure propose a four-port hybrid coupler, that builds on the principles used for the design of quadrature microstrip slot couplers. The aim in some examples is to have a 3 dB coupling, which is referred to as tight coupling. In that case, the power in a given input port is equally divided between two output ports, and the fourth port is isolated. It should be noted that arbitrary values of coupling could be obtained, and examples of this disclosure may also apply to arbitrary coupling values. The coupler introduces a 90° phase difference between the signals of the output ports. In some examples, there are two lines or electrically conductive portions, one on each side of a dielectric core, to give four ports in total. A common ground plane is located in the middle of the core. The coupling between the two lines is made possible using two elliptic patches facing each other through an elliptic slot in the ground plane.

At least some example directional couplers disclosed herein can be modified into or configured as phase shifters, for example by not connecting certain inputs/outputs (and in some examples, electrical connections to the unused inputs/outputs of a directional coupler configured as a phase shifter may be omitted). For example, instead of four ports, only two ports are used, an input and an output. A phase shift is obtained between the output of the phase shifter and that of a reference line. Such a device may be used for example to introduce the necessary phase shifts in a feeding network that cannot be produced by the coupler alone, typically 45°. In some examples, the layout or structure of the phase shifter is the same as that of example directional couplers disclosed herein, but each patch (or electrically conductive portion) is only connected to one section of line, so to one port instead of two.

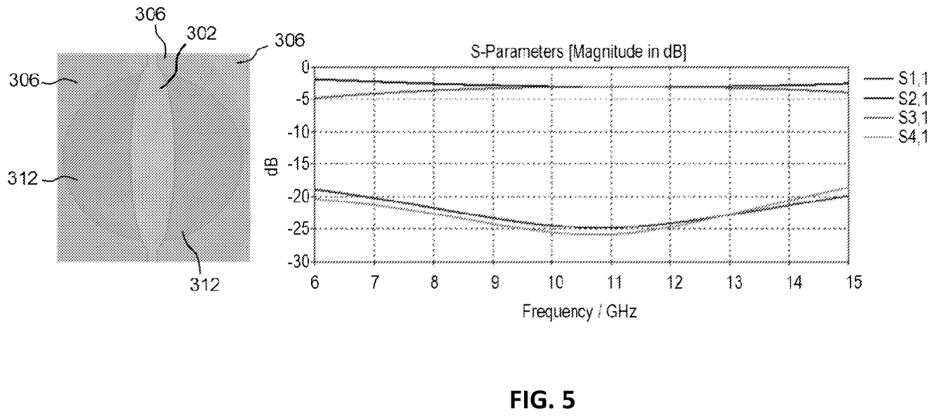

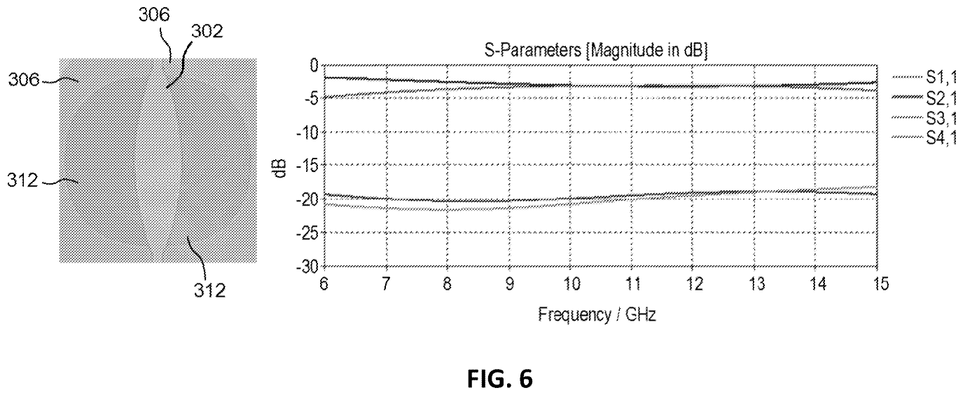

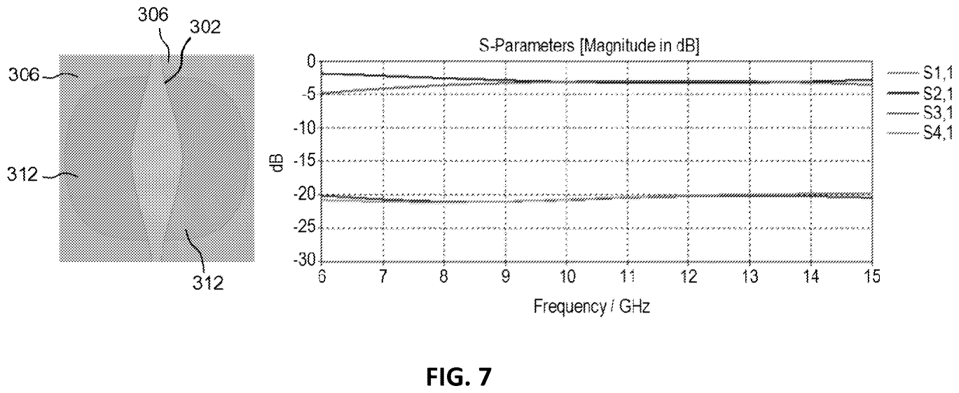

FIGS. 5, 6 and 7 each show a plan view of a directional coupler, similar to the directional coupler 300 shown in FIGS. 3 and 4, but with different shapes for the first 302 and second 304 electrically conductive portions and the hole 312. In each case, the shape of the first 302 and second 304 electrically conductive portions and the hole 312 are defined in part or as a whole as a superellipse.

In some examples, the directional coupler 300 may be formed in a process for forming or manufacturing a Printed Circuit Board (PCB) based on a stack-up of multiple substrate layers. For example, the second ground plane electrical conductor 308 may in some examples be formed in a first layer of a Printed Circuit Board (PCB), the first electrically conductive portion 302 is formed in a second layer of the PCB, the first ground plane electrical conductor 306 is formed in a third layer of the PCB, the second electrically conductive portion 304 is formed in a fourth layer of the PCB, and the third ground plane electrical conductor 310 is formed in a fifth layer of the PCB. These steps may be reversed in some examples. There may also be one or more other layers between any of these layers.

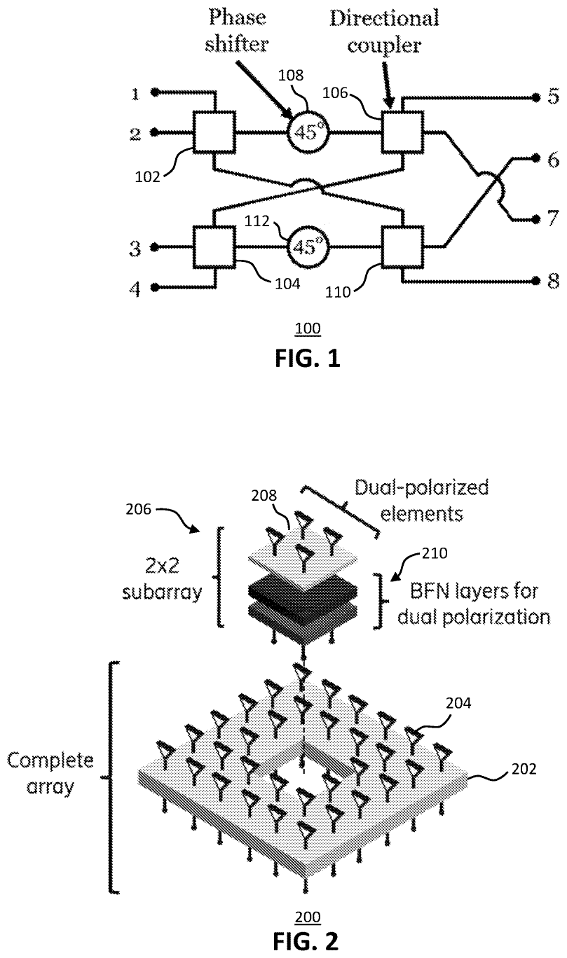

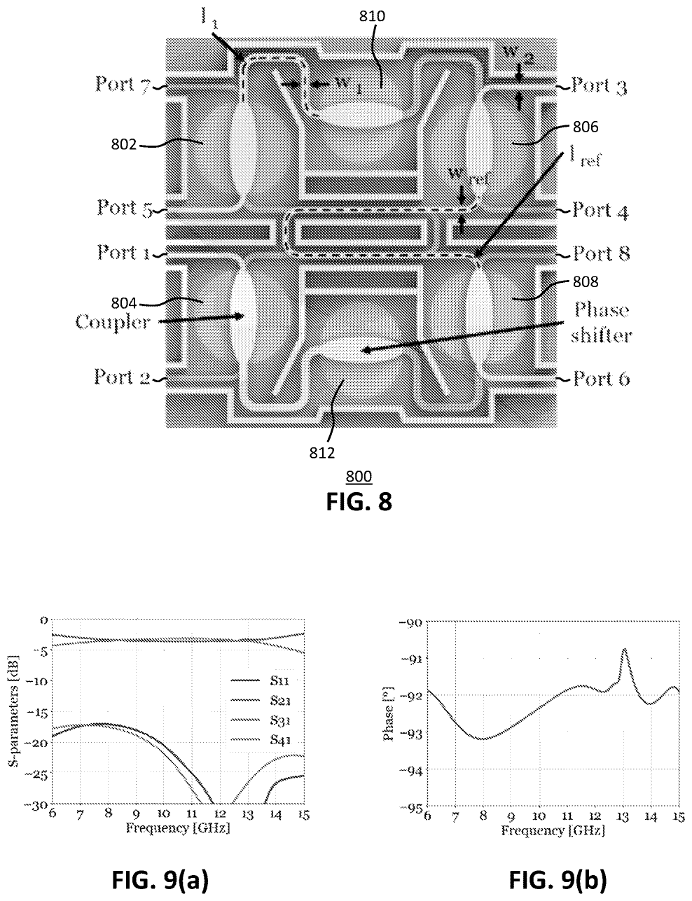

The directional couplers described herein, such as for example those shown in FIGS. 3-7, may be used in any suitable device, such as for example a Butler matrix. FIG. 8 shows a plan view of an example of a Butler matrix 800, which includes directional couplers and phase shifters as described herein. The Butler matrix 800 includes a first directional coupler 802, second directional coupler 804, third directional coupler 806 and fourth directional coupler 808. The Butler matrix also includes a first phase shifter 810 and second phase shifter 812. These components may be connected in a manner as shown in FIG. 1. Thus, for example, the directional couplers 802, 804, 806 and 808 may be connected in the same manner as directional couplers 102, 104, 106 and 110 respectively, and the phase shifters 810 and 812 may be connected in the same manner as the phase shifters 108 and 112 respectively.

Input ports to the Butler matrix 800 are ports 1 to 4 as shown in FIG. 8, and are provided to the directional couplers 804, 804, 806 and 806 respectively. The outputs ports from the Butler matrix 800 are ports 5 to 8 shown in FIG. 8, and are connected to the directional couplers 802, 808, 802 and 808 respectively.

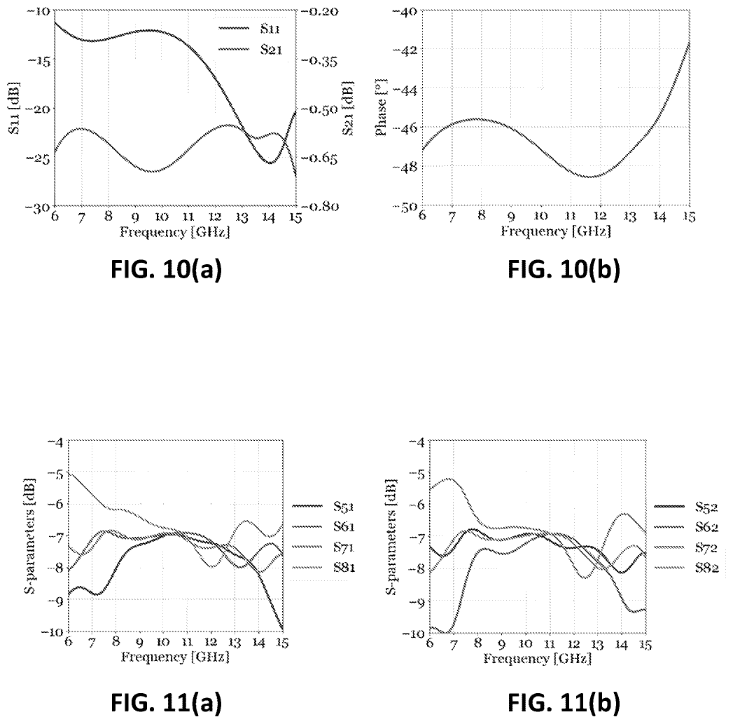

FIGS. 9 and 10 show simulation results of example directional couplers and phase shifters as disclosed herein, such as for example the directional coupler 300 shown in FIGS. 3 and 4. Specifically, FIG. 9(a) shows simulated S-parameters of the coupler, and FIG. 9(b) shows simulated difference of phase between the outputs of the coupler. FIG. 10(a) shows simulated S-parameters of the phase shifter (e.g. directional coupler 300 configured as a phase shifter), and FIG. 10(b) shows simulated difference of phase between the outputs of the phase shifter. The simulated S-parameters of the couplers shown in FIGS. 5-7 are shown adjacent to the corresponding coupler in those Figures.

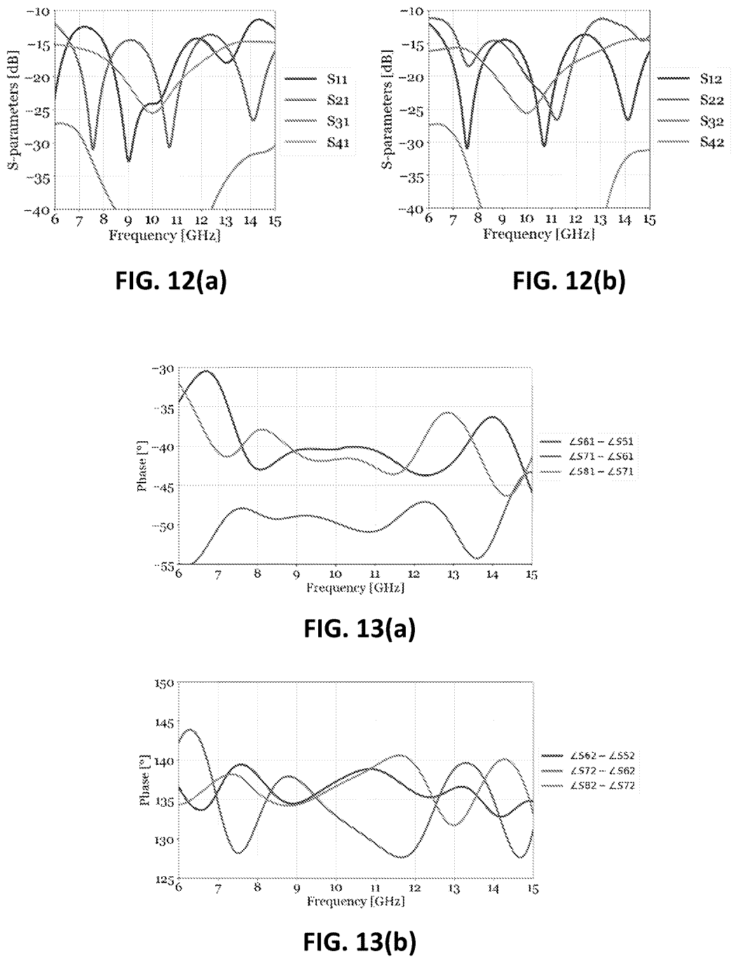

FIGS. 11-13 show simulation results of an example Butler matrix, such as the Butler matrix 800 of FIG. 8. Specifically, FIG. 11(a) shows simulated insertion losses of the Butler matrix when exciting port 1, and FIG. 11(b) shows simulated insertion losses of the Butler matrix when exciting port 2. FIG. 12(a) shows simulated reflection and isolation of the Butler matrix when exciting port 1, and FIG. 12(b) shows simulated reflection and isolation of the Butler matrix when exciting port 2. FIG. 13(a) shows phase differences between consecutive output ports when exciting port 1, and FIG. 13(b) shows phase differences between consecutive output ports when exciting port 2.

For examples of the directional coupler described here, in use, the first electrically conductive portion and the second electrically conductive portion may be coupled by a transverse electromagnetic (TEM) or quasi-TEM mode.

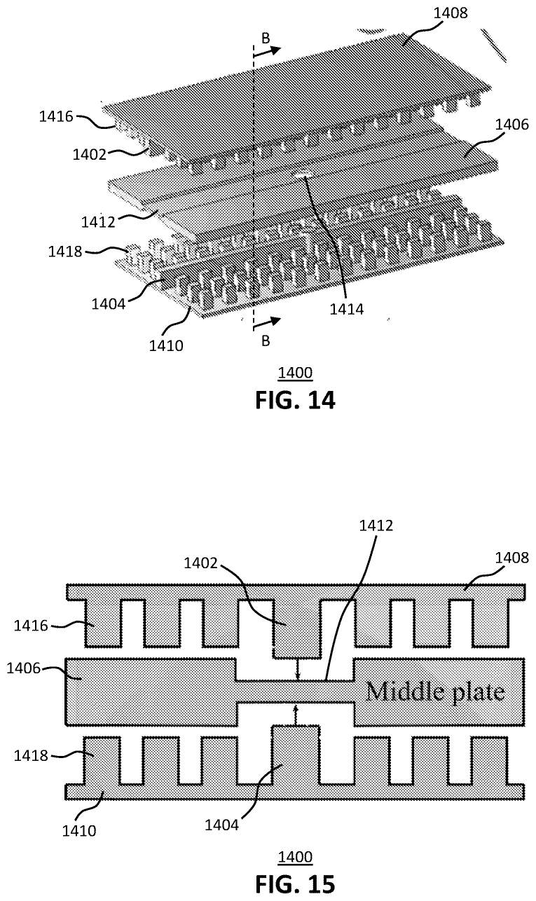

In some examples, the first electrically conductive portion comprises a ridge in the second ground plane electrical conductor, and the second electrically conductive portion comprises a ridge in the third ground plane electrical conductor. FIG. 14 shows an exploded view of an example of a directional coupler 1400 according to this arrangement. FIG. 15 shows a cross section of the directional coupler 1400 of FIG. 14 along the line B-B shown in FIG. 14. In some examples, the directional coupler 1400 may be referred to as a ridge gap waveguide (RGW) directional coupler.

As shown, the directional coupler 1400 includes a first electrically conductive portion 1402 and a second electrically conductive portion 1404, and a first ground plane electrical conductor 1406 disposed in a plane between the first electrically conductive portion and the second electrically conductive portion. As shown in FIGS. 14 and 15, the first electrically conductive portion 1402 and the second electrically conductive portion 1404 are formed as ridges in a second ground plane electrical conductor 1408 and a third ground plane electrical conductor 1410. The second 1408 and third 1410 ground plane electrical conductors are generally planar and substantially parallel to each other and to the first ground plane electrical conductor 1406 (this may also be the case for other example directional couplers described herein).

As shown in FIGS. 14 and 15, the ridge 1402 in the second ground plane electrical conductor 1408 protrudes from the second ground plane electrical conductor 1408 towards the ridge 1404 in the third ground plane electrical conductor 1410, and vice versa. In addition, in the example directional coupler 1400, the ridge 1402 in the second ground plane electrical conductor 1408 protrudes into a first channel (or groove, such as an elongate groove) in a first side of the first ground plane electrical conductor 1406, and the ridge in the third ground plane electrical conductor 1410 protrudes into a second channel (or groove, such as an elongate groove) in a second side of the first ground plane electrical conductor 1406 opposite the first side. Thus, the channels define a section 1412 of reduced thickness of the first ground plane electrical conductor 1406, wherein the length of the reduced thickness section 1412 is oriented generally along the same direction as the ridges 1402 and 1404.

In the example shown, at least one hole (here, one hole 1414) is formed in the section of reduced thickness 1412 of the first ground plane electrical conductor. The second ground plane electrical conductor 1408 also includes a plurality of pins 1416 protruding towards the first ground plane electrical conductor 1406, and the third ground plane electrical conductor 1410 includes a plurality of pins 1418 protruding towards the first ground plane electrical conductor 1406. The pins with the ground plane electrical conductor 1408 act as an electromagnetic band hole structure, meaning that no propagation is allowed. For example, the pins are dimensioned so that no propagating modes are supported in 20-40 GHz band.

In some examples, given the correct excitation, there will be a propagation between a ridge and the ground plane electrical conductor on which it is formed. If we excite outside the operational frequency of the electromagnetic bandgap structure, in some examples, this will result in a field and propagation of a signal.

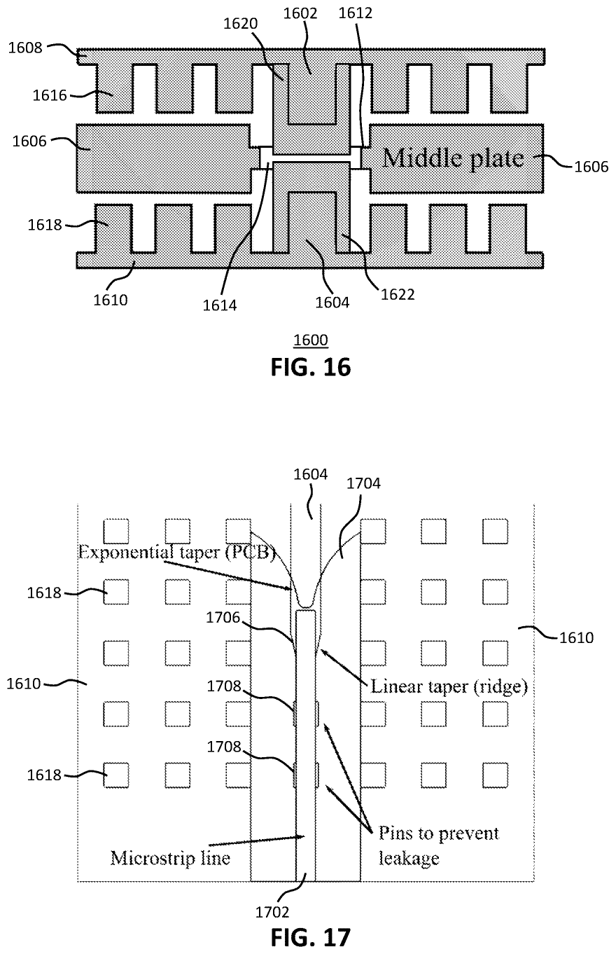

In some examples of directional couplers described herein, at least a portion of the first electrically conductive portion protrudes into the at least one hole, and/or at least a portion of the second electrically conductive portion protrudes into the at least one hole. FIG. 16 shows a cross section of an example of a directional coupler 1600 according to this arrangement. Similar to the coupler 1400 shown in FIGS. 14 and 15, the directional coupler 1600 includes a first electrically conductive portion 1602 and a second electrically conductive portion 1604, and a first ground plane electrical conductor 1606 disposed in a plane between the first electrically conductive portion 1602 and the second electrically conductive portion 1604. The first electrically conductive portion 1602 and the second electrically conductive portion 1604 are formed as ridges in a second ground plane electrical conductor 1608 and a third ground plane electrical conductor 1610. The second 1608 and third 1610 ground plane electrical conductors are generally planar and substantially parallel to each other and to the first ground plane electrical conductor 1606.

The ridge 1602 in the second ground plane electrical conductor 1608 protrudes from the second ground plane electrical conductor 1608 towards the ridge 1604 in the third ground plane electrical conductor 1610, and vice versa. In addition, the ridge 1602 in the second ground plane electrical conductor 1608 protrudes into a first channel in a first side of the first ground plane electrical conductor 1606, and the ridge in the third ground plane electrical conductor 1610 protrudes into a second channel in a second side of the first ground plane electrical conductor 1606 opposite the first side. Thus, the channels define a section 1612 of reduced thickness of the first ground plane electrical conductor 1606, wherein the length of the reduced thickness section 1612 is oriented generally along the same direction as the ridges 1602 and 1604.

In the example shown, at least one hole (here, one hole 1614) is formed in the section of reduced thickness 1412 of the first ground plane electrical conductor. The cross section shown in FIG. 16 is taken through the hole 1614 such that it is visible in FIG. 16. The second ground plane electrical conductor 1608 also includes a plurality of pins 1616 protruding towards the first ground plane electrical conductor 1606, and the third ground plane electrical conductor 1610 includes a plurality of pins 1618 protruding towards the first ground plane electrical conductor 1606.

In the example coupler 1600 shown in FIG. 16, the first electrically conductive portion 1602 includes a protrusion 1620 towards the hole 1614 such that it protrudes into the hole 1614. Similarly, the second electrically conductive portion 1604 includes a protrusion 1622 towards the hole 1614 such that it protrudes into the hole 1614. Such an arrangement results for example in a hole between the first and second electrically conductive portions being smaller than the thickness of the section of reduced thickness 1612 in the first ground plane electrical conductor 1606.

In some examples of a RGW directional coupler such as those shown in FIGS. 14-16, the coupling between the two waveguides (i.e. the first and second electrically conductive portions formed as ridges in the respective ground plane electrical conductors) is achieved by creating an elliptical hole (hole) in the first ground plane electrical conductor (shown as hole 1414 in FIG. 14 and hole 1614 in FIG. 16) and having two elliptical coupling elements (e.g. the protrusions 1620 and 1622) to increase the coupling. The coupling elements (e.g. the protrusions 1620 and 1622) in some examples are approximately quarter wavelength long, or are less than a quarter of the shortest wavelength for which the coupler will be used, and have higher height than the ridge to increase the coupling between them. After the width of the slot and the coupling element are set, the height of the patch can be adjusted in some examples to obtain the desired coupling. The size of the hole may in some examples be slightly larger than the length of the coupling elements, so that the coupling elements are not shorted to the first ground plane electrical conductor.

The coupling element 1600 was simulated in CST Microwave Studio with a lossy aluminum model.

To simulate the directional coupler, the structure is interfaced to a connector. In the simulation, this is achieved via a microstrip line to RGW transition. FIG. 17 shows a plan view of an example of this arrangement, which shows a part of the third ground plane electrical conductor of FIG. 16. Also shown is a microstrip line 1702, which provides an electrical connection to one end of the second electrically conductive portion 1604 (ridge). Similar arrangements are provided at the opposite end of the second electrically conductive portion 1604 as well as each end of the first electrically conductive portion 1602, thus providing four electrical connections to the simulated directional coupler.

The microstrip line 1702 was chosen as it allows for easy integration with the rest of the circuit (not shown). The key insight in developing the transition was noting that the mode of the microstrip line is like the mode in the RGW. This means that it is possible to design a transition between the two geometries where the modes change gradually, which minimizes reflections. This approach has been shown to produce excellent matching in [22].

The transition consists of the printed circuit board (PCB) plate 1704 with the microstrip line 1702. The PCB plate 1704 is fixed into the channel in the first ground plate electrical conductor 1606 (i.e. the channel that forms the section of reduced thickness in the first ground plane electrical conductor 1606) the and pressed onto the ridge (second electrically conductive portion 1604) so that the microstrip line 1702 and the ridge align, as seen in FIG. 17, and a solid electrical connection is obtained. The transition is matched by creating an exponential taper 1706 at the end of the PCB plate 1704, as show. The taper allows for the mode to gradually adapt to the new geometry without reflecting. However, a portion of the mode in a microstrip line is present outside of the dielectric material. This portion would get reflected and reradiated upon meeting the ridge in the RGW, increasing radiation leakage. To mitigate this, the ending of the ridge is linearly tapered in some examples, such as the linear taper 1706 shown in FIG. 17, though this can be implemented in any of the examples disclosed herein that use ridges for electrically conductive portions.

The radiation leakage may in some examples be further reduced by placing two pins 1708 before the start of the ridge, underneath the microstrip line 1702, as in [22]. These two pins block undesired propagation in a similar manner as the pins in a gap waveguide. Their height is adjusted so that the best performance is obtained and doesn't need to be the same as the pins in a RGW, such as for example the pins 1618 shown in FIGS. 16 and 17.

The structure shown in FIGS. 16 and 17 and described above was simulated in electromagnetic simulation software CST from Dassault Systems using lossy aluminium and Rogers RO4003C models. The simulation results exhibit good performance, with the structure being matched to below −15 dB. The insertion loss is lower than 1 dB for most of the band, and most of the losses come from the presence of lossy dielectric.

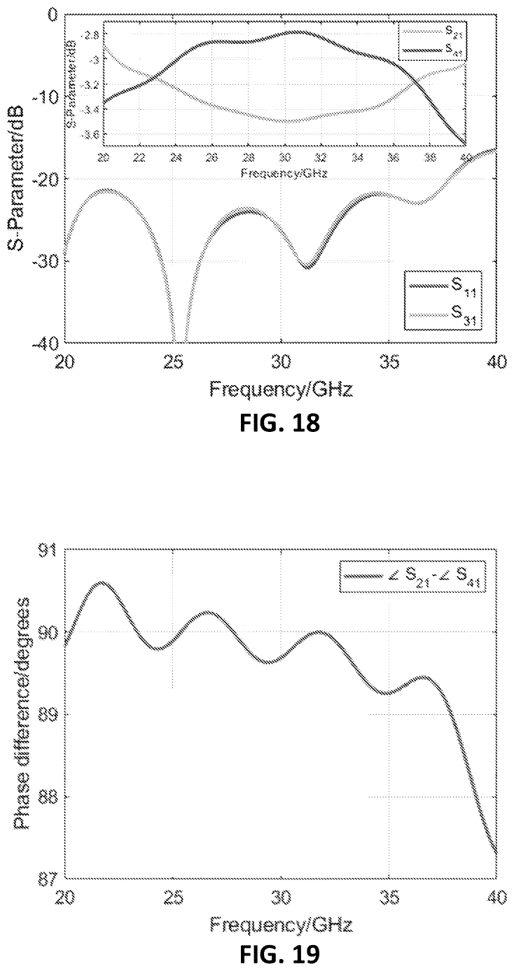

The simulated coupling element exhibits excellent performance throughout the band. The structure is matched below −15 dB for the entire band and is matched below −20 dB for all frequencies in 20-37.8 GHz. Furthermore, 3 dB coupling with a maximum deviation of 0.7 dB is achieved, as seen in FIG. 18, which shows simulated S-parameters of the example directional coupler 1600 shown in FIG. 16. The obtained phase difference between the two outgoing signals is 90 degrees with a maximum deviation of about 3 degrees, as seen in FIG. 19, which shows simulated phase difference of outgoing signals from the example directional coupler 1600 shown in FIG. 16.

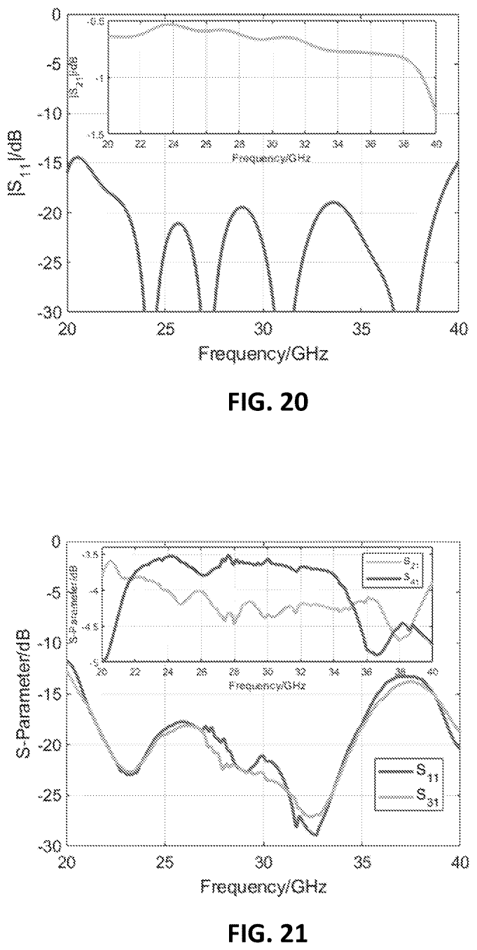

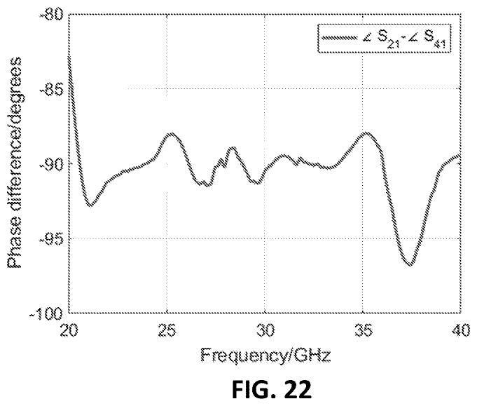

The overall performance is shown in FIG. 20, which shows simulation results for the structure shown in FIGS. 16 and 17. FIG. 21 shows Simulated S-parameters of the structure, and FIG. 22 shows simulated phase difference between two outgoing signals of the structure. The structure matched better than −10 dB for entire band and −15 dB for 21-36 GHz. The S_21 and S_41 parameters are between −5 and −3.5 dB for the entire band. The obtained phase shift is 90 degrees with a maximum deviation of 7 degrees. The main factor limiting performance in the assembled coupler is the transition from microstrip to RGW

Gap waveguides, such as for example those shown in FIGS. 14-17 and described above, make use of the phenomenon that no mode can propagate in a parallel plate waveguide consisting of a perfect electrical conductor (PEC) and perfect magnetic conductor (PMC) when the gap between them is less than quarter wavelength. Thus, if a portion of the PMC plate contains a strip of PEC, the wave is effectively confined to its area and propagates only across the PEC strip. However, this cannot be directly implemented, as PMC materials do not exist. Thus, a metamaterial may be used to imitate its effects. This can be done with periodically repeating pins, such as the pins shown in FIGS. 14-17. The ridge allows the signal to travel along it, while the pins block any propagation.

In planar PCB technology, in some examples, it is possible to construct a wideband hybrid by using multilayer technology, with a microstrip line on top, a ground plane in the middle and another microstrip line in the bottom of the structure, as presented in FIG. 3 for example. To transfer power from one port to another, a hole is made in the ground plane and two coupling elements (patches) of approximately quarter wavelength (or less than a quarter wavelength, such as for example less than a quarter of the shortest wavelength for which the coupler will be used) are used to couple energy to the other side of the structure. The strength of the coupling depends on the width of the ellipse and the substrate used, whereas the phase shift is achieved by having the patch be approximately quarter wavelength long (or less than the quarter wavelength as referred to above).

Directional couplers as described herein may be used in any suitable device, such as for example a Butler matrix, Blass matrix or Nolen matrix. In some examples, a device incorporating one or more couplers as described herein may comprise a plurality of arrays of antennas, e.g. a plurality of M×N arrays of antennas, where N and M are positive integers. In a particular example, each M×N array of antennas is connected to a Butler matrix, Blass Matrix or Nolen matrix, and wherein each matrix includes at least one directional coupler as disclosed herein. Each M×N matrix may be for example a 2×2 matrix. Each matrix may for example be connected to and within a footprint of a respective M×N array of antennas. In some examples, each M×N array of antennas is connected to a further Butler, Blass or Nolan matrix, for example where two polarizations are used. Each further matrix may be connected to and within a footprint of a respective M×N array of antennas. In some examples, each M×N array of antennas and the respective matrix and further matrix may be connected to the M×N array of antennas in a stacked configuration, such as for example illustrated in FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single device or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Any reference signs in the statements shall not be construed so as to limit their scope.

### REFERENCES

1. Marzieh SalarRahimi and Guy A. E. Vandenbosch. “Beam steerable subarray with small footprint for use as building block in wall mounted indoor wireless infrastructure”. en. In: IET Microwaves, Antennas & Propagation 13.4 (March 2019), pp. 526-531. ISSN: 1751-8733, 1751-8733. DOI: 10. 1049/iet-map. 2018.6189. URL: https://onlinelibrary.wiley.com/doi/10.1049/iet-map.2018.6189 (visited on Mar. 1, 2022).
2. Petros I. Bantavis, Christos I. Kolitsidas, Tzihat Empliouk, Marc Le Roy, B. Lars G. Jonsson, and George A. Kyriacou. “A Cost-Effective Wideband Switched Beam Antenna System for a Small Cell Base Station”. In: IEEE Transactions on Antennas and Propagation 66.12 (December 2018), pp. 6851-6861. ISSN: 1558-2221. DOI: 10.1109/TAP.2018.2874494.
3. Amin M. Abbosh and Marek E. Bialkowski. “Design of Compact Directional Couplers for UWB Applications”. In: IEEE Transactions on Microwave Theory and Techniques 55.2 (February 2007), pp. 189-194. ISSN: 1557-9670. DOI: 10. 1109/TMTT.2006.889150.
4. Amin M. Abbosh. “Ultra-Wideband Phase Shifters”. In: IEEE Transactions on Microwave Theory and Techniques 55.9 (September 2007), pp. 1935-1941. ISSN: 1557-9670. DOI: 10.1109/TMTT.2007.904051.
5. ZAMAN, Ashraf Uz, et al. Design of a simple transition from microstrip to ridge hole waveguide suited for MMIC and antenna integration. IEEE Antennas and wireless propagation letters, 2013, 12:1558-1561.
6. SHAMS, Shoukry I.; KISHK, Ahmed A. Design of 3-dB hybrid coupler based on RGW technology. IEEE Transactions on Microwave Theory and Techniques, 2017, 65.10:3849-3855.
7. NASR, Mohamed A.; KISHK, Ahmed A. Analysis and Design of Broadband Ridge-Hole-Waveguide Tight and Loose Hybrid Couplers. IEEE Transactions on Microwave Theory and Techniques, 2020, 68.8:3368-3378.
8. SUN, Dongquan; XU, Jinping. Rectangular waveguide coupler with adjustable coupling coefficient using hole waveguide technology. Electronics Letters, 2016, 53.3:167-169.

1. A directional coupler comprising:
a first electrically conductive portion and a second electrically conductive portion;
a first ground plane electrical conductor disposed in a plane between the first electrically conductive portion and the second electrically conductive portion; and
a second ground plane electrical conductor and a third ground plane electrical conductor disposed such that the first and second electrically conductive portions and the first ground plane electrical conductor are between the second and third ground plane electrical conductors;
wherein the first ground plane electrical conductor includes at least one hole directly between the first electrically conductive portion and the second electrically conductive portion.

2. The directional coupler of claim 1, wherein the first electrically conductive portion, the second electrically conductive portion and the first ground plane electrical conductor are not electrically connected together.

3-10. (canceled)

11. The directional coupler of claim 1, wherein a size of the first hole is larger than one of a size of the first electrically conductive portion and a size of the second electrically conductive portion.

12. The directional coupler of claim 1, wherein the first, second and third ground plane electrical conductors are substantially parallel.

13. The directional coupler of claim 1, wherein the second ground plane electrical conductor is disposed above the first electrically conductive portion, and the third ground plane electrical conductor is disposed below the second electrically conductive portion.

14. The directional coupler of claim 1, comprising a first air hole or substrate between the first electrically conductive portion and the second ground plane electrical conductor, and a second air hole or substrate between the second electrically conductive portion and the third ground plane electrical conductor.

15. The directional coupler of claim 1, wherein the first ground plane electrical conductor is embedded within a substrate.

16. The directional coupler of claim 15, wherein at least one of the first electrically conductive portion is disposed on a first surface of the substrate, and the second electrically conductive portion is disposed on a second surface of the substrate opposite the first surface.

17. The directional coupler of claim 1, wherein the second ground plane electrical conductor is formed in a first layer of a Printed Circuit Board (PCB), the first electrically conductive portion is formed in a second layer of the PCB, the first ground plane electrical conductor is formed in a third layer of the PCB, the second electrically conductive portion is formed in a fourth layer of the PCB, and the third ground plane electrical conductor is formed in a fifth layer of the PCB.

18. The directional coupler of claim 1, wherein the first electrically conductive portion comprises a ridge in the second ground plane electrical conductor, and the second electrically conductive portion comprises a ridge in the third ground plane electrical conductor.

19. The directional coupler of claim 18, wherein at least one of the ridge in the second ground plane electrical conductor protrudes from the second ground plane electrical conductor towards the ridge in the third ground plane electrical conductor, and the ridge in the third ground plane electrical conductor protrudes from the third ground plane electrical conductor towards the ridge in the second ground plane electrical conductor.

20. The directional coupler of claim 18, wherein at least one of the ridge in the second ground plane electrical conductor protrudes into a first channel in a first side of the first ground plane electrical conductor, and the ridge in the third ground plane electrical conductor protrudes into a second channel in a second side of the first ground plane electrical conductor opposite the first side.

21. The directional coupler of claim 20, wherein the first and second channels define a section of reduced thickness in the first ground plane electrical conductor.

22. The directional coupler of claim 21, wherein the at least one hole is formed in the section of reduced thickness of the first ground plane electrical conductor.

23. The directional coupler of claim 18, wherein the second ground plane electrical conductor includes a plurality of pins protruding towards the first ground plane electrical conductor, and/or the third ground plane electrical conductor includes a plurality of pins (1418, 1618) protruding towards the first ground plane electrical conductor.

24. The directional coupler of claim 1, wherein at least one of at least a portion of the first electrically conductive portion protrudes into the at least one hole, and at least a portion of the second electrically conductive portion protrudes into the at least one hole.

25. The directional coupler of claim 1, wherein, in use, the first electrically conductive portion and the second electrically conductive portion are coupled by a transverse electromagnetic (TEM) or quasi-TEM mode.

26-27. (canceled)

28. A device including at least one directional coupler according to claim 1.

29. The device of claim 28, wherein the device comprises at least one of a Butler matrix, Blass matrix, and Nolan matrix.

30-35. (canceled)
